(19) United States
(12) Patent Application Publication
(10) Pub. No.: US 2026/0060889 A1
(43) Pub. Date: Mar. 5, 2026

(54) MASSAGE DEVICE

(71) Applicant: Shenzhen Winyi Technology Co.,Ltd, ShenZhen (CN)

(72) Inventor: Yong ZHANG, ShenZhen (CN)

(73) Assignee: Shenzhen Winyi Technology Co.,Ltd, ShenZhen (CN)

(21) Appl. No.: 19/380,385

(22) Filed: Nov. 5, 2025

(30) Foreign Application Priority Data
Apr. 21, 2025 (CN) 202520774992.7

(51) Int. Cl. A61H 23/02

(52) U.S. Cl. CPC A61H 23/0254

(57) ABSTRACT

A massage device includes a first housing and a second housing. A telescopic transmission assembly is provided in the first housing, and a vibration module is provided in the second housing. A screw is connected to the telescopic transmission assembly, and a limiting ring is provided in the first housing. The limiting ring is threadedly connected to the screw, the screw extends out of the first housing, and an end of the screw extending out of the first housing is connected to the second housing. An elastic protective layer is sleeved outside the first housing and the second housing. When the telescopic transmission assembly drives the screw to perform reciprocating motion in an axial direction, the screw is able to rotate back and forth relative to the limiting ring and drive the second housing to perform reciprocating motion in an axial direction and perform twist motion back and forth.

### CROSS-REFERENCE TO RELATED APPLICATIONS

This application claims priority to Chinese Patent Application No. 202520774992.7 with a filing date of Apr. 21, 2025. The content of the aforementioned application, including any intervening amendments thereto, is incorporated herein by reference.

### TECHNICAL FIELD

The present disclosure relates to the technical field of health care equipment, and in particular, to a massage device.

### BACKGROUND

The massage device is a type of health care equipment designed to replace manual massage. With the continuous increase in work-related stress, it has become a relatively common household device for achieving relaxation.

Massage devices generally fall into two categories: handheld and seat-mounted. Among them, the handheld type is quite popular for its simplicity of use, ease of operation, and freedom from spatial constraints. The existing handheld massage devices are typically motor-driven. The massage intensity is varied by adjusting the motor's speed, which in turn alters the vibration frequency. However, this massage mode is monotonous in function, and other massage modes cannot be adopted for complementary massage, failing to better meeting user experience.

### SUMMARY OF PRESENT INVENTION

The technical problem to be solved by embodiments of the present disclosure is to provide a massage device, which can enhance the diversity of massage modes, thereby improving the massage experience.

The present disclosure discloses a massage device, including: a first housing and a second housing, a telescopic transmission assembly is provided in the first housing, a vibration module is provided in the second housing, a screw is connected to the telescopic transmission assembly, a limiting ring is provided in the first housing, the limiting ring is threadedly connected to the screw, the screw extends out of the first housing, an end of the screw extending out of the first housing is connected to the second housing, an elastic protective layer is sleeved outside the first housing and the second housing, and when the telescopic transmission assembly drives the screw to perform reciprocating motion in an axial direction, the screw is able to rotate back and forth relative to the limiting ring and drive the second housing to perform reciprocating motion in an axial direction and perform twist motion back and forth.

Optionally, the telescopic transmission assembly includes a gear motor, a connecting seat connected to the gear motor, a sliding sleeve axially and slidably connected to an outer circumference of the connecting seat, and a transmission shaft provided in the connecting seat; the transmission shaft is in transmission connection to the gear motor, the sliding sleeve is connected to the screw, an opening extending in an axial direction is formed in one side of the connecting seat, the sliding sleeve is provided with a guide rod engaged with the transmission shaft, and the guide rod is able to pass through the opening to be engaged with the transmission shaft, such that the transmission shaft drives the sliding sleeve to perform linear reciprocating motion in an axial direction.

Optionally, an outer circumference of the transmission shaft is provided with a right-hand spiral groove and a left-hand spiral groove, two ends of the right-hand spiral groove and two ends of the left-hand spiral groove are correspondingly communicated, and an end of the guide rod passing through the opening is snap-fitted with the right-hand spiral groove and the left-hand spiral groove and is able to slide along the right-hand spiral groove and the left-hand spiral groove.

Optionally, the sliding sleeve is snap-fitted with a pressing block, the guide rod is clamped between the pressing block and the sliding sleeve, and the pressing block is able to slide along the opening.

Optionally, the connecting seat includes a base, and a sleeve connected to the base; an outer circumference of the sleeve is shaped as a regular polygon, and an inner circumference of the sliding sleeve is profiled to match the regular polygon, such that the sleeve is slidably connected to the sliding sleeve.

Optionally, the sliding sleeve is rotatably connected to the screw through a connector, the connector includes a first half body and a second half body buckled with each other, the sliding sleeve is provided with a first connecting portion corresponding to the first half body and a second connecting portion corresponding to the second half body, the first connecting portion is provided with a first limiting shaft, the second connecting portion is provided with a second limiting shaft, the first half body is engaged with the first connecting portion, the first limiting shaft passes through the first half body and the second half body, the second half body is engaged with the second connecting portion, and the second limiting shaft passes through the second half body.

Optionally, an annular limiting slot is formed between the first half body and the second half body, an end of the screw connected to the connector is provided with an annular limiting member, and the annular limiting member is able to be snap-fitted in the annular limiting slot.

Optionally, a limiting cap is connected to an end of the screw far away from the sliding sleeve, a snap slot corresponding to the limiting cap is formed in the second housing, and the limiting cap is snap-fitted in the snap slot.

Optionally, a storage battery and a circuit board electrically connected to the storage battery are further provided in the first housing, the telescopic transmission assembly and the vibration module are separately electrically connected to the circuit board, and the circuit board is further provided with control buttons for controlling the telescopic transmission assembly and the vibration module to operate.

Optionally, the elastic protective layer is made of silica gel, a limiting protrusion is provided at a position of the elastic protective layer corresponding to the second housing, and a limiting slot snap-fitted with the limiting protrusion is formed outside the second housing.

Compared with the prior art, the massage device provided in the embodiments of the present disclosure has the following beneficial effects: by providing the telescopic transmission assembly in the first housing, and connecting the screw to the telescopic transmission assembly, the screw can drive the second housing to perform the reciprocating motion in the axial direction. In addition, by providing the limiting ring in the first housing and threadedly connected to the screw, the screw can rotate under the action of the limiting ring during axial movement, to drive the second housing to perform the twist motion back and forth, and in combination with the vibration of the vibration module in the second housing, various combined massage modes can be provided for users. Furthermore, the elastic protective layer can be in direct contact with skin. On the one hand, the buffer action of the elastic protective layer prevents the massage device from severe damage even the users touch other objects by accident during use and improves the touch comfort. On the other hand, the elastic protective layer protects the first housing and the second housing while protecting internal components such as the telescopic transmission assembly and the vibration module, such that when the first housing and the second housing leave away from each other, the integrity and smoothness of the outer surface of the massage device can be ensured, thereby ensuring the stability during use. This mode can enhance the diversity of massage modes during use, thereby improving massage experience.

### BRIEF DESCRIPTION OF THE DRAWINGS

The technical solution of the present disclosure is further described below in detail with reference to the accompanying drawings and the embodiments. In the accompanying drawings:

FIG. 1 is a schematic structural diagram of a massage device according to embodiments of the present disclosure;

FIG. 2 is a schematic cross-sectional diagram of a massage device according to embodiments of the present disclosure;

FIG. 3 is a schematic diagram of a local structure of a massage device according to embodiments of the present disclosure; and

FIG. 4 is an exploded structural diagram of a telescopic transmission assembly and a screw according to embodiments of the present disclosure.

Reference numerals in the accompanying drawings:
100. Massage device; 110. First housing; 112. Limiting ring; 1122. Threaded port; 120. Second housing; 122. Snap slot; 124. Limiting slot; 130. Telescopic transmission assembly; 131. Gear motor; 132. Connecting seat; 1322. Base; 1324. Sleeve; 1325. Opening; 133. Sliding sleeve; 1332. Pressing block; 1334. First connecting portion; 1334a. First limiting shaft; 1336. Second connecting portion; 1336a. Second limiting shaft; 134. Transmission shaft; 135. Connector; 1352. First half body; 1354. Second half body; 1356. Annular limiting slot; 140. Vibration module; 150. Screw; 152. Annular limiting member; 154. Limiting cap; 160. Elastic protective layer; 162. Limiting protrusion; 170. Storage battery; 180. Circuit board; and 190. Control button.

### DETAILED DESCRIPTION OF THE EMBODIMENTS

It should be noted that the embodiments in the present disclosure and features in the embodiments may be combined with each other in a non-conflicting situation. The preferred embodiment of the present disclosure is described in detail with reference to the accompanying drawings.

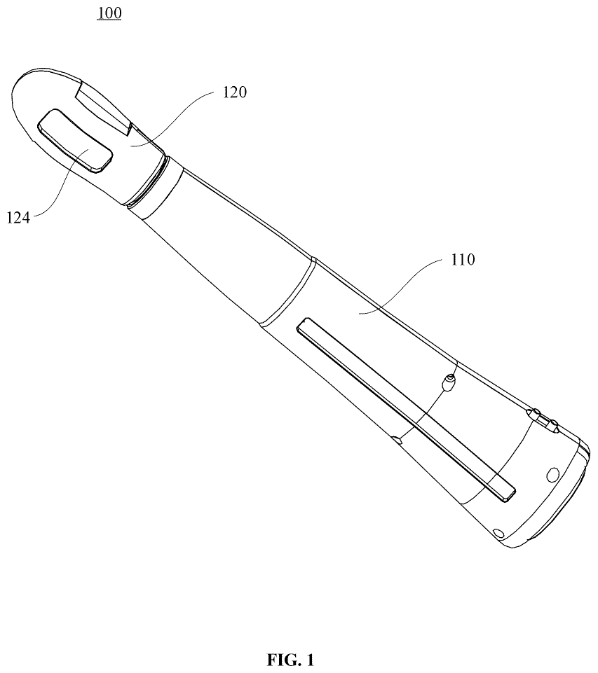

As shown in FIG. 1 to FIG. 4, the embodiments of the present disclosure provide a massage device 100, including: a first housing 110 and a second housing 120. A telescopic transmission assembly 130 is provided in the first housing 110, and a vibration module 140 is provided in the second housing 120. A screw 150 is connected to the telescopic transmission assembly 130, a limiting ring 112 is provided in the first housing 110, the limiting ring 112 is threadedly connected to the screw 150, the screw 150 extends out of the first housing 110, and an end of the screw 150 extending out of the first housing 110 is connected to the second housing 120. An elastic protective layer 160 is sleeved outside the first housing 110 and the second housing 120. When the telescopic transmission assembly 130 drives the screw 150 to perform reciprocating motion in an axial direction, the screw 150 is able to rotate back and forth relative to the limiting ring 112 and drive the second housing 120 to perform reciprocating motion in an axial direction and perform twist motion back and forth.

Specifically, the first housing 110 is separated from the second housing 120, the telescopic transmission assembly 130 is arranged in the first housing 110, and the vibration module 140 is arranged in the second housing 120. The telescopic transmission assembly 130 is connected to the screw 150, the limiting ring 112 is arranged in the first housing 110, and the screw 150 is threadedly connected to the limiting ring 112. When the telescopic transmission assembly 130 drives the screw 150 to perform reciprocating motion in an axial direction, the screw 150 can rotate back and forth relative to the limiting ring 112 due to the characteristics of the threaded connection. Furthermore, an end of the screw 150 extending out of the first housing 110 is connected to the second housing 120, such that the movement of the screw 150 can drive the second housing 120 to perform reciprocating motion in an axial direction and perform twist motion back and forth. In this way, the second housing 120 can be driven to approach or move away from the first housing 110, and under the vibration of the vibration module 140, the first housing 110 is twisted under the action of the screw 150, to form various forms of massage actions. The vibration module 140 can adopt a common form where a motor is connected to a cam, and vibrates by means of the eccentric amount of the cam and the arm length of a crankshaft.

According to the massage device 100 provided in the embodiments of the present disclosure, the telescopic transmission assembly 130 is provided in the first housing 110, and the screw 150 is connected to the telescopic transmission assembly 130, such that the screw 150 can drive the second housing 120 to perform the reciprocating motion in the axial direction. In addition, the limiting ring 112 is provided in the first housing 110 and threadedly connected to the screw 150, such that the screw 150 can rotate under the action of the limiting ring 112 during axial movement, to drive the second housing 120 to perform the twist motion back and forth, and in combination with the vibration of the vibration module 140 in the second housing 120, various combined massage modes can be provided for users. Furthermore, the elastic protective layer 160 can be in direct contact with skin. On the one hand, the buffer action of the elastic protective layer 160 prevents the massage device 100 from severe damage even the users touch other objects by accident during use and improves the touch comfort. On the other hand, the elastic protective layer 160 protects the first housing 110 and the second housing 120 while protecting internal components such as the telescopic transmission assembly 130 and the vibration module 140, such that when the first housing 110 and the second housing 120 leave away from each other, the integrity and smoothness of the outer surface of the massage device 100 can be ensured, thereby ensuring the stability during use. This mode can enhance the diversity of massage modes during use, thereby improving massage experience.

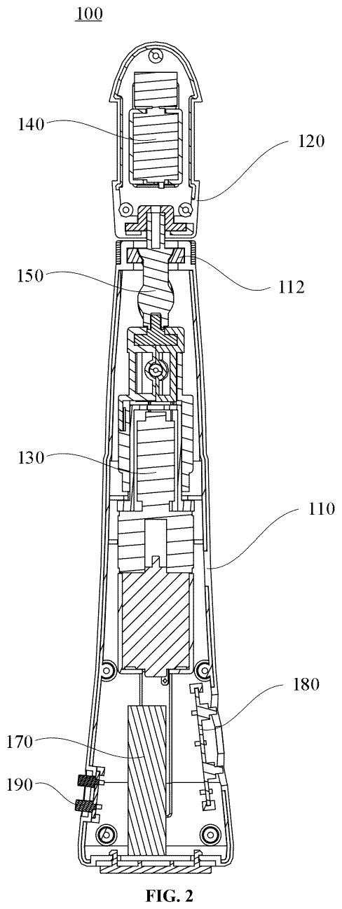

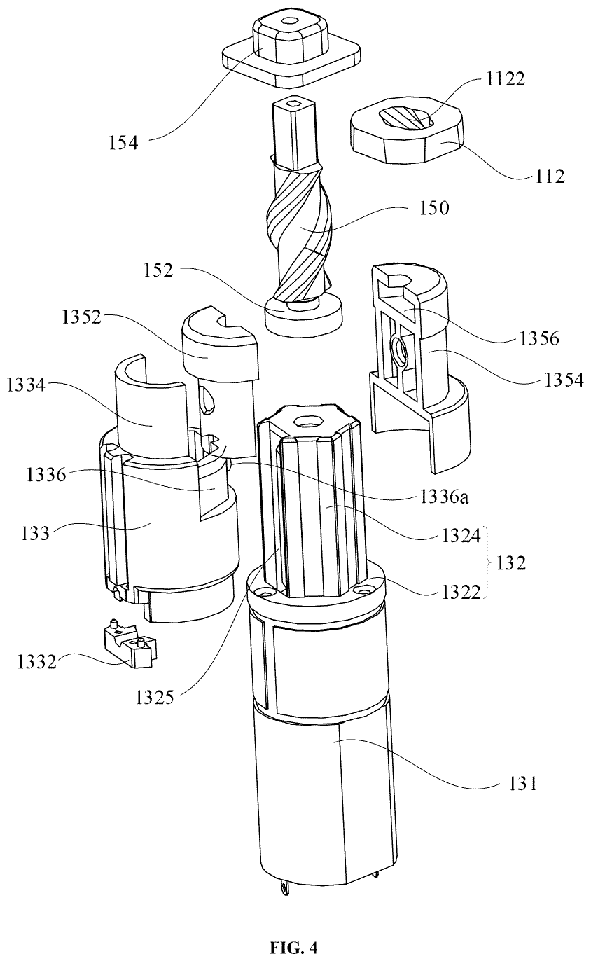

As shown in FIG. 2 and FIG. 4, the telescopic transmission assembly 130 includes a gear motor 131, a connecting seat 132 connected to the gear motor 131, a sliding sleeve 133 axially and slidably connected to an outer circumference of the connecting seat 132, and a transmission shaft 134 provided in the connecting seat 132. The transmission shaft 134 is in transmission connection to the gear motor 131, the sliding sleeve 133 is connected to the screw 150, an opening 1325 extending in an axial direction is formed in one side of the connecting seat 132, the sliding sleeve 133 is provided with a guide rod engaged with the transmission shaft 134, and the guide rod is able to pass through the opening 1325 to be engaged with the transmission shaft 134, such that the transmission shaft 134 drives the sliding sleeve 133 to perform linear reciprocating motion in an axial direction.

Specifically, the gear motor 131, as a power source, provides initial power for the whole assembly. The connecting seat 132 is connected to the gear motor 131 to achieve power and support other components. The sliding sleeve 133 is axially and slidably connected to the outer circumference of the connecting seat 132, and the transmission shaft 134 is arranged in the connecting seat 132 and in transmission connection to the gear motor 131. The sliding sleeve 133 is connected to the screw 150, to finally transfer the power of the gear motor 131 to the screw 150. The opening 1325 extending in an axial direction is formed in one side of the connecting seat 132, and the guide rod is arranged on the sliding sleeve 133 and is able to pass through the opening 1325 to be engaged with the transmission shaft 134. When the transmission shaft 134 is driven by the gear motor 131 to rotate, the guide rod can be engaged with the transmission shaft 134 to drive the sliding sleeve 133 to perform linear reciprocating motion in an axial direction, thereby driving the connected screw 150 to perform reciprocating motion in an axial direction.

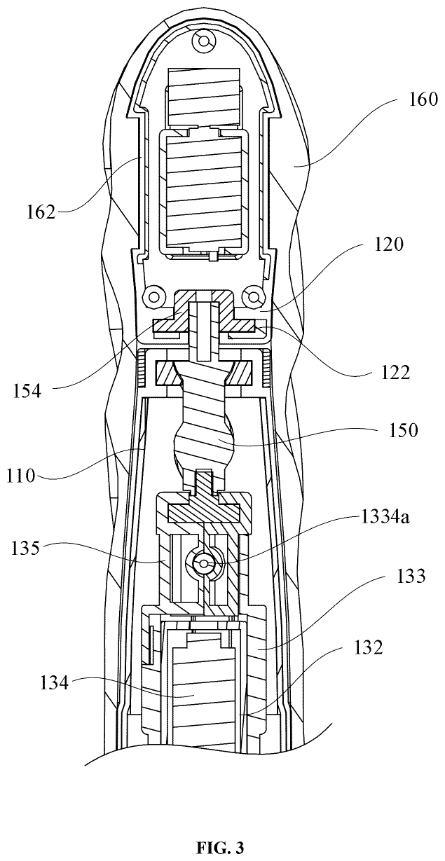

As shown in FIG. 3 and FIG. 4, an outer circumference of the transmission shaft 134 is provided with a right-hand spiral groove and a left-hand spiral groove, two ends of the right-hand spiral groove and two ends of the left-hand spiral groove are correspondingly communicated, and an end of the guide rod passing through the opening 1325 is snap-fitted with the right-hand spiral groove and the left-hand spiral groove and is able to slide along the right-hand spiral groove and the left-hand spiral groove.

Specifically, an end of the guide rod passing through the opening 1325 is snap-fitted with the right-hand spiral groove and the left-hand spiral groove and is able to slide along the right-hand spiral groove and the left-hand spiral groove. When the transmission shaft 134 rotates, the guide rod slides successively in the right-hand spiral groove and the left-hand spiral groove. Because the right-hand spiral groove and the left-hand spiral groove are in different directions, the sliding sleeve 133 is driven to perform linear reciprocating motion in an axial direction.

As shown in FIG. 4, the sliding sleeve 133 is snap-fitted with a pressing block 1332, the guide rod is clamped between the pressing block 1332 and the sliding sleeve 133, and the pressing block 1332 is able to slide along the opening 1325.

Specifically, the sliding sleeve 133 is snap-fitted with the pressing block 1332, and the guide rod is clamped between the pressing block 1332 and the sliding sleeve 133. The pressing block 1332 functions to further fix the position of the guide rod, preventing the guide rod from deviating or falling during movement, thereby ensuring that the guide rod and the right-hand spiral groove and the left-hand spiral groove on the transmission shaft 134 are always kept in a stable snap-fit state. The pressing block 1332 can slide along the opening 1325 on the connecting seat 132, without affecting the linear reciprocating motion of the sliding sleeve 133 in the axial direction while ensuring the fixation of the guide rod. In addition, when the guide rod is worn, this mode facilitates the replacement of the guide rod, improving the convenience for later maintenance.

As shown in FIG. 4, the connecting seat 132 includes a base 1322, and a sleeve 1324 connected to the base 1322. An outer circumference of the sleeve 1324 is shaped as a regular polygon, and an inner circumference of the sliding sleeve 133 is profiled to match the regular polygon, such that the sleeve 1324 is slidably connected to the sliding sleeve 133.

Specifically, the connecting seat 132 includes the base 1322, and the sleeve 1324 connected to the base 1322. The outer circumference of the sleeve 1324 is shaped as a regular polygon, and the inner circumference of the sliding sleeve 133 is profiled to match the regular polygon. This special shape matching realizes slidable connection between the sleeve 1324 and the sliding sleeve 133 while limiting the rotation of the sliding sleeve 133 in the circumferential direction, thereby ensuring that the sliding sleeve 133 can perform linear motion only in the axial direction of the sleeve 1324, conforming to the original design intention of the telescopic transmission assembly 130, and ensuring the accuracy of power transfer.

As shown in FIG. 4, the sliding sleeve 133 is rotatably connected to the screw 150 through a connector 135. The connector 135 includes a first half body 1352 and a second half body 1354 buckled with each other. The sliding sleeve 133 is provided with a first connecting portion 1334 corresponding to the first half body 1352 and a second connecting portion 1336 corresponding to the second half body 1354. The first connecting portion 1334 is provided with a first limiting shaft 1334a, and the second connecting portion 1336 is provided with a second limiting shaft 1336a. The first half body 1352 is engaged with the first connecting portion 1334, and the first limiting shaft 1334a passes through the first half body 1352 and the second half body 1354. The second half body 1354 is engaged with the second connecting portion 1336, and the second limiting shaft 1336a passes through the second half body 1354.

Specifically, in this way, when the sliding sleeve 133 is connected to the screw 150 through the connector 135, the screw 150 can be limited between the first half body 1352 and the second half body 1354 directly through the engagement between the first half body 1352 and the second half body 1354, realizing the required connection relationship. The first half body 1352 is engaged with the first connecting portion 1334, and the first limiting shaft 1334a passes through the first half body 1352 and the second half body 1354. The second half body 1354 is engaged with the second connecting portion 1336, and the second limiting shaft 1336a passes through the second half body 1354. In practical applications, there is a certain distance in the axial direction between the first limiting shaft 1334a and the second limiting shaft 1336a, avoiding an excessively centralized stress at the junction, ensuring the connection reliability and stability.

As shown in FIG. 4, an annular limiting slot 1356 is formed between the first half body 1352 and the second half body 1354, an end of the screw 150 connected to the connector 135 is provided with an annular limiting member 152, and the annular limiting member 152 is able to be snap-fitted in the annular limiting slot 1356.

Specifically, an end of the screw 150 connected to the connector 135 is provided with the annular limiting member 152, and the annular limiting member 152 is able to be snap-fitted in the annular limiting slot 1356. The limiting structure further limits relative movement between the screw 150 and the connector 135, such that during operation of the massage device 100, the screw 150 cannot be detached from the connector 135 during axial movement and rotation, thereby ensuring the connection stability and reliability.

As shown in FIG. 3 and FIG. 4, a limiting cap 154 is connected to an end of the screw 150 far away from the sliding sleeve 133, a snap slot 122 corresponding to the limiting cap 154 is formed in the second housing 120, and the limiting cap 154 is snap-fitted in the snap slot 122.

Specifically, the limiting cap 154 is snap-fitted in the snap slot 122. In this way, the connection between the screw 150 and the second housing 120 is more stable, and accurate positioning is provided for the movement of the second housing 120. In the massage process, the second housing 120 can perform reciprocating motion in an axial direction and twist motion back and forth according to an expected trajectory and mode, thus improving the accuracy and consistency of massage actions, and improving user experience. The second housing 120 can adopt a separate connection mode, facilitating the engagement between the limiting cap 154 and the second housing 120, and also facilitating the assembling of the vibration module 140.

As shown in FIG. 2, a storage battery 170 and a circuit board 180 electrically connected to the storage battery 170 are further provided in the first housing 110, the telescopic transmission assembly 130 and the vibration module 140 are separately electrically connected to the circuit board 180, and the circuit board 180 is further provided with control buttons 190 for controlling the telescopic transmission assembly 130 and the vibration module 140 to operate.

Specifically, the storage battery 170 is arranged in the first housing 110 to provide power for the massage device 100, ensuring normal operation without an external power supply, and improving the convenience for use. The circuit board 180 is electrically connected to the storage battery 170 to control and distribute power. The telescopic transmission assembly 130 and the vibration module 140 are separately electrically connected to the circuit board 180. Through the control buttons 190 on the circuit board 180, users can conveniently control the telescopic transmission assembly 130 and the vibration module 140 to operate, thereby adjusting parameters such as massage mode, strength and frequency. The first housing 110 may adopt a separate connection form, facilitating the assembling of the storage battery 170 and the telescopic transmission assembly 130 in the first housing 110.

In optional embodiments of the present disclosure, the elastic protective layer 160 is made of silica gel, a limiting protrusion 162 is provided at a position of the elastic protective layer 160 corresponding to the second housing 120, and a limiting slot 124 snap-fitted with the limiting protrusion 162 is formed outside the second housing 120.

Specifically, the snap-fitting between the limiting protrusion 162 and the limiting slot 124 makes the connection between the elastic protective layer 160 and the second housing 120 more stable. During the use of the massage device 100, even in the case of external force pulling or collision, the elastic protective layer 160 can be always maintained at a correct position to continuously protect the second housing 120 and internal components such as the vibration module 140, preventing protection failure caused by the displacement of the elastic protective layer 160. In practical applications, no matter the second housing 120 performs the axial motion or the radial twist motion, the elastic protective layer 160 and the second housing 120 can be stably engaged, ensuring the reliability during use.

It should be understood that the above embodiments are only used to explain the technical solution of the present disclosure, not to limit it. For those skilled in the art, the technical solution recorded in the above embodiments may be modified or some of the technical features may be replaced equivalently. All such modifications and substitutions shall fall within the scope of protection of the appended claims of the present disclosure.

What is claimed is:

1. A massage device, comprising: a first housing and a second housing, wherein a telescopic transmission assembly is provided in the first housing, a vibration module is provided in the second housing, a screw is connected to the telescopic transmission assembly, a limiting ring is provided in the first housing, the limiting ring is threadedly connected to the screw, the screw extends out of the first housing, an end of the screw extending out of the first housing is connected to the second housing, an elastic protective layer is sleeved outside the first housing and the second housing, and the telescopic transmission assembly is configured to drive the screw to perform reciprocating motion in an axial direction, and the screw is hence able to rotate back and forth relative to the limiting ring and drive the second housing to perform reciprocating motion in an axial direction and perform twist motion back and forth.

2. The massage device according to claim 1, wherein the telescopic transmission assembly comprises a gear motor, a connecting seat connected to the gear motor, a sliding sleeve axially and slidably connected to an outer circumference of the connecting seat, and a transmission shaft provided in the connecting seat; the transmission shaft is in transmission connection to the gear motor, the sliding sleeve is connected to the screw, an opening extending in an axial direction is formed in one side of the connecting seat, the sliding sleeve is provided with a guide rod engaged with the transmission shaft, and the guide rod is able to pass through the opening to be engaged with the transmission shaft, whereby the transmission shaft drives the sliding sleeve to perform linear reciprocating motion in an axial direction.

3. The massage device according to claim 2, wherein an outer circumference of the transmission shaft is provided with a right-hand spiral groove and a left-hand spiral groove, two ends of the right-hand spiral groove and two ends of the left-hand spiral groove are correspondingly communicated, and an end of the guide rod passing through the opening is snap-fitted with the right-hand spiral groove and the left-hand spiral groove and is able to slide along the right-hand spiral groove and the left-hand spiral groove.

4. The massage device according to claim 3, wherein the sliding sleeve is snap-fitted with a pressing block, the guide rod is clamped between the pressing block and the sliding sleeve, and the pressing block is able to slide along the opening.

5. The massage device according to claim 4, wherein the connecting seat comprises a base, and a sleeve connected to the base; an outer circumference of the sleeve is shaped as a regular polygon, and an inner circumference of the sliding sleeve is profiled to match the regular polygon, whereby the sleeve is slidably connected to the sliding sleeve.

6. The massage device according to claim 2, wherein the sliding sleeve is rotatably connected to the screw through a connector, the connector comprises a first half body and a second half body buckled with each other, the sliding sleeve is provided with a first connecting portion corresponding to the first half body and a second connecting portion corresponding to the second half body, the first connecting portion is provided with a first limiting shaft, the second connecting portion is provided with a second limiting shaft, the first half body is engaged with the first connecting portion, the first limiting shaft passes through the first half body and the second half body, the second half body is engaged with the second connecting portion, and the second limiting shaft passes through the second half body.

7. The massage device according to claim 6, wherein an annular limiting slot is formed between the first half body and the second half body, an end of the screw connected to the connector is provided with an annular limiting member, and the annular limiting member is able to be snap-fitted in the annular limiting slot.

8. The massage device according to claim 2, wherein a limiting cap is connected to an end of the screw far away from the sliding sleeve, a snap slot corresponding to the limiting cap is formed in the second housing, and the limiting cap is snap-fitted in the snap slot.

9. The massage device according to claim 1, wherein a storage battery and a circuit board electrically connected to the storage battery are further provided in the first housing, the telescopic transmission assembly and the vibration module are separately electrically connected to the circuit board, and the circuit board is further provided with control buttons for controlling the telescopic transmission assembly and the vibration module to operate.

10. The massage device according to claim 1, wherein the elastic protective layer is made of silica gel, a limiting protrusion is provided at a position of the elastic protective layer corresponding to the second housing, and a limiting slot snap-fitted with the limiting protrusion is formed outside the second housing.
